(19) United States
(12) Patent Application Publication
(10) Pub. No.: US 2018/0200542 A1
(43) Pub. Date: Jul. 19, 2018

(54) DESCENDING DEVICE FOR PERSONS FROM A BUILDING

(71) Applicant: XSPLATFORMS B.V., Gorinchem (NL)

(72) Inventors: Geert COX, Son (NL); Allert GORT, Leiderdorp (NL); Matthijs VOGELS, Rotterdam (NL)

(21) Appl. No.: 15/743,339

(22) PCT Filed: Jul. 8, 2016
(86) PCT No.: PCT/NL2016/050511

§ 371 Date: Jan. 10, 2018

(30) Foreign Application Priority Data
Jul. 10, 2015 (NL) 2015134
Mar. 1, 2016 (NL) 2016343

(51) Int. Cl. A62B 1/14; A62B 1/10; F16H 57/10; F16D 59/00

(52) U.S. Cl. CPC A62B 1/14; F16D 59/00; F16H 57/10; A62B 1/10

(57) ABSTRACT

A device has a ceiling unit provided with a cap which when moving to an open position, lowers a guide under the influence of the force of gravity to an obliquely downwardly directed position. In this position, under the influence of the force of gravity or by means of a gas spring, an arm 15 slides along the guide and via a window to the outside. On the end of the arm there is a cable guide 19 over which a descending cable 21 is turned.

Descending units 27 are present on the descending cable. Each descending unit has a cable wheel 37 around which the descending cable is turned. The cable wheel is connected to the housing of the descending unit via a centrifugal brake. This centrifugal brake ensures that the speed of rotation of the cable wheel and therefore the descent speed is not too high.

Furthermore, the descending unit has a further centrifugal brake which ensures additional braking in case the descent speed exceeds a certain limit.

### TECHNICAL FILED OF THE INVENTION

The invention relates to a device for descending people from, for example, a building, comprising:
a ceiling unit provided with an extendable arm having a cable guide at the free end,
a cable drum provided with a brake that restricts the rotation speed of the cable drum,
a descending cable wound on the cable drum and turned over the cable guide having at its end coupling means for coupling to a harness.

### BACKGROUND OF THE INVENTION

Such a device is known from WO 2007/113886 A1. When evacuating a harness is put on a person and this harness is connected to the coupling means. Then the person gets out of the window and the descending cable unwinds controlled from the cable drum. The brake ensures that the descending cable does not unwind to quickly. After this person is down, he/she puts off the harness, after which the descending cable again winds on the cable drum by winding springs present in the cable drum. Now, a second person can descend in the same manner.

### SUMMARY OF THE INVENTION

An object of the invention is to provide a device of the type described in the opening paragraph which enables people to be evacuated more rapidly than with the known apparatus. To this end, the device according to the invention, is characterized in that the device further comprises at least one descending unit which is present on the descending cable in the ceiling unit and is movable along the descending cable, which descending unit comprises:
a housing, as well as
a cable wheel shaft connected to the housing,
a rotatable cable wheel present on the cable wheel shaft, over which wheel the descending cable is turned and which wheel is connected to the housing via a freewheel and a centrifugal brake,
two guide wheels which guide the descending cable to and from the cable wheel, and
further coupling means for coupling to a further harness,
   which centrifugal brake comprises two coupling parts connected with each other comprises, of which a first part is connected to the cable wheel and a second part, in the direction of rotation, is fixed relative to the housing.

After a first person is descending by the cable drum, further persons may descend along the descending cable with the aid of the descending units. There is no need to wait until the first person is completely down. One does not have to wait until the second person is down but shortly after the second person the third person can start to descend. The descending cable does not have to be wound on the cable drum every time a person has descended. This allows people to be evacuated more rapidly than with the known apparatus.

The freewheel prevents activation of the centrifugal brake during the descent of the first person.

The cable wheel can hereby be fixed on the cable wheel shaft and the cable wheel shaft may be journalled in the housing or the cable wheel shaft may be fixed in the housing and the cable wheel mounted on the cable wheel shaft.

An embodiment of the device according to the invention is characterized in that the descending unit comprises a planetary gear set with three rotation bodies, of which a first rotation body is connected to said cable wheel and a second rotating body is connected to the first part of the centrifugal brake. Hereby, the third rotation body can be attached to the housing or to the cable wheel shaft if the latter is attached to the housing. The centrifugal brake brakes the descending unit while descending along the descending cable. Using a planetary gear set, the descending unit can be kept compact.

A further embodiment of the device according to the invention is characterized in that a third rotation body of the planetary gear set is attached to a further centrifugal brake comprising two inter-connectable further parts, of which a first further part is connected to the cable wheel and a second further part, in the direction of rotation, is fixed relative to the housing. This further centrifugal brake ensures that the descent of a heavy additional person is inhibited if the descent rate is likely to rise above a certain limit due to insufficient braking capacity of the centrifugal brake.

A further embodiment of the device according to the invention, in that:
the descending unit further comprises a star wheel provided with teeth, said star wheel is rotatably connected to the housing,
wherein the teeth each are provided with a guide groove near the end,
wherein the guide grooves in the teeth extend along a circular arc, and
wherein the further coupling means are provided with a guide profile extending over a distance along a portion of the circular arc, which distance is greater than or equal to two times the distance along the arc of a circle along which the guide grooves extends between two adjacent teeth.

This construction makes it possible that the descending unit can pass the cable guide. The cable guide is formed by a rotatable cable wheel which is present on a wheel axle. The star wheel collides during descent with a tooth against the wheel axle and rotates about the wheel axle through an angle of about 90 degrees from a horizontal to a vertical position. During the rotation of the descending unit and the star wheel the further coupling means move through the guide grooves in the teeth of the star wheel and the further coupling means maintain the same orientation. Preferably, the descending unit has two star wheels, one on each side of the descending cable.

Preferably, the descending cable is turned around the cable wheel over an angle of at least 240 degrees. As a result, the chance of slipping of the descending cable over the cable wheel is greatly reduced.

### BRIEF DESCRIPTION OF THE DRAWINGS

The invention will be further elucidated below on the basis of drawings. These drawings show an embodiment of the device according to the present invention. In the drawings:

FIG. 1 shows the device in start position;

FIG. 2 shows the device with the housing pushed aside and the guide lowered:

FIG. 3 shows the device with extended arm;

FIG. 4 shows the device during the descent of a first person;

FIG. 5 shows the device during the descent of a second person;

FIG. 6 is a descending unit on the descending cable in cross-section:

FIG. 7 shows the descending unit on the descending cable with the housing omitted;

FIG. 8 shows the descending unit on the descending cable before passing the cable guide;

FIG. 9 shows the descending unit on the descending cable after passing the cable guide while descending along the descending cable; and

FIG. 10 shows the descending unit on the descending cable in front view during passing the cable guide.

### DETAILED DESCRIPTION OF THE DRAWINGS

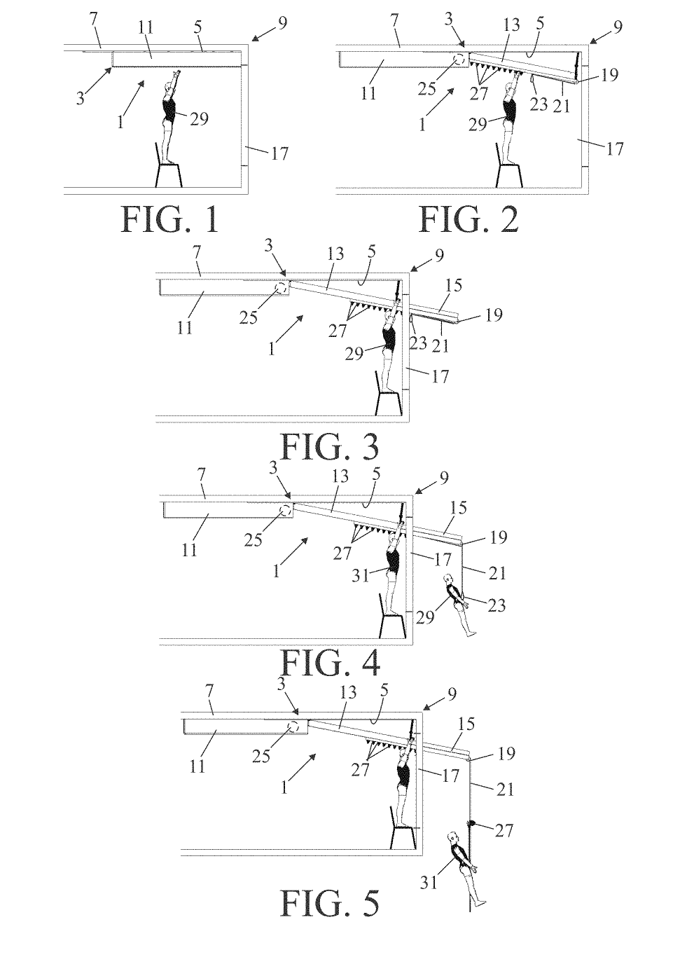

In the FIGS. 1-5 step by step the use of the device according to the invention is shown during the evacuation of persons present on a high floor of a building. The device 1 has a ceiling unit 3 provided with a frame 5 which is attached to the ceiling 7 of a floor of a building 9. The ceiling unit further has a cap 11 which can be shifted with respect to the frame. In FIG. 1, the cap 11 is in closed position. When shifting the cap 11 to the open position, as shown in FIG. 2, a guide 13 rotates under the influence of the force of gravity or forced by means of a (gas) spring from a horizontal position to an obliquely downwardly directed position. In the obliquely downwardly directed position an arm 15 moves under the influence of the force of gravity or forced by means of a (gas) spring along the guide and via a window 17 to the outside, as shown in FIG. 3. In the extended position the free end of the arm 15 extends at least 1 meter outside the wall of the building. The free end of the arm is provided with a cable guide 19 which is formed by a guide wheel over which a descending cable 21 is turned. At the free end of descending cable there are coupling means formed by a fastening eye 23.

The ceiling unit is equipped with a braked winch provided with a cable drum 25 on which the descending cable is wound. The cable drum is connected to the frame of the ceiling unit via a centrifugal brake (not shown in the figures). The centrifugal brake has two parts cooperating with each other, one of which is fixed in the direction of rotation to the cable drum and the other one is fixed in the direction of rotation to the frame of the ceiling unit. Between the cable drum 25 and the cable guide 19 descending units 27 are present on the descending cable 21.

The first person descending 29 does not use the descending units 27 but lowers himself down through the braked winch. To this end, this person first pulls a harness which then is fastened to the fastening eye 23. Then this person 29 gets out of the window 17, and the descending cable 21 unwinds from the cable drum 25 in a manner controlled by the centrifugal brake; see FIG. 4. During the descent of the first person 29 a second person 31 can prepare him/herself by also pulling a harness and linking it with the front descending unit 27. After the first person has commenced the descent, the second person can descend along the descending cable using the descending unit. A centrifugal brake present in descending unit ensures that the descent speed is not too high. A further centrifugal brake in the descending unit serves as an additional brake in the event the first centrifugal brake cannot deliver sufficient braking force, especially when descending a heavy person.

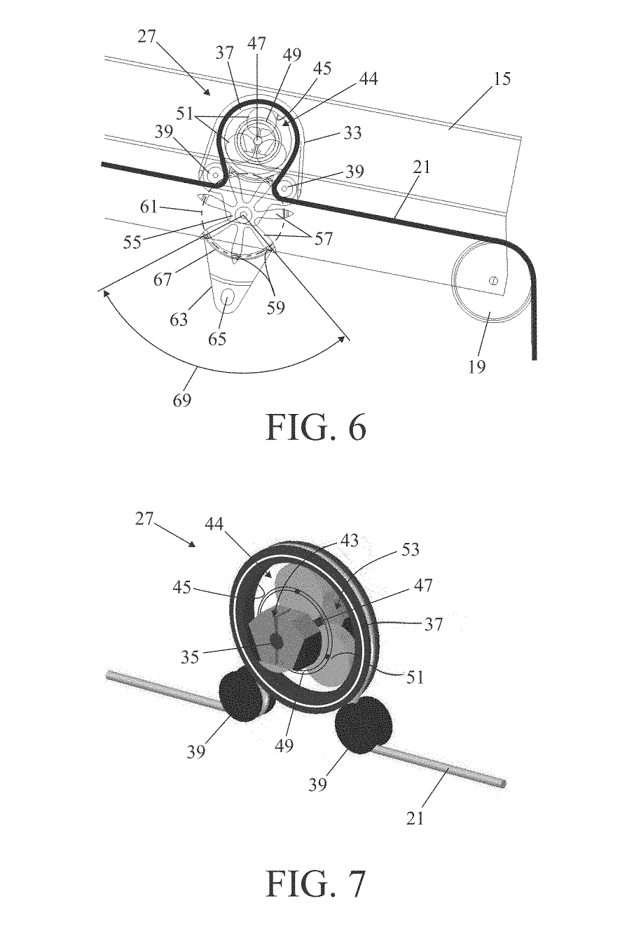

In FIGS. 6 and 7 one of the descending units 27 present on the descending cable 21 is shown respectively in cross-section and in perspective view with the omission of the housing. The descending unit has a housing 33 and a rotatably cable wheel shaft 35 mounted therein to which shaft a cable wheel 37 is attached around which the descending cable is turned. Furthermore, the descending unit has two guide wheels 39 which are rotatably connected to the housing and which guide the descending cable to and from the cable wheel. Both guide wheels are positioned such that the descending cable runs along an omega-shaped path through the descending unit, wherein the descending cable has been turned around the cable wheel over an angle of about 270 degrees.

The cable wheel 37 is connected to the cable wheel shaft via a free-wheel 41 (see FIG. 7). This freewheel ensures that if the descending unit is stationary relative to the ceiling unit and the descending cable unwinds from cable drum during the descent of the first person, the cable wheel can rotate freely relative to the housing.

The cable wheel shaft 35 is further connected to the housing via a centrifugal brake 43. This centrifugal brake ensures that the rotational speed of the cable wheel 37 and thereby the descent speed is not too high. This centrifugal brake has two parts connected to each other, of which a first part is connected to the cable wheel shaft or the cable wheel and a second part in the direction of rotation is fixed relative to the housing 33.

The descending unit 27 has a planetary gear set 44 with three rotation bodies, of which a first rotation body 45 is formed by a ring wheel which is connected to the cable wheel 37 via the free wheel 41 and a second rotation body 47 is formed by a sun wheel which is mounted on the cable wheel shaft 35. A third rotation body 49 of the planetary gear set is formed by a planet carrier on which there are three rotatable planet gears 51 which are in engagement with the ring gear and the sun gear. This planet carrier is fastened to a first part of a further centrifugal brake 53 (not visible in the figures because it is located at the rear side) which is connected to the cable wheel or the cable wheel shaft. The second part of this further centrifugal brake is also fixed in rotation direction to the housing.

The descending unit 27 further has a star wheel 55 which is rotatably connected to the housing and which is provided with teeth 57. Close to the end 59 of the teeth these teeth are provided with a guide groove. The guide grooves in the teeth extend along a circular arc 61. The descending unit is further provided with further coupling means formed by a suspension element 63 provided with a further fastening eye 65. This suspension element is provided with a guide profile 67 which extends over a distance 69 along a portion of the circular arc 61. This distance 69 is greater than or equal to two times the distance along the arc of a circle between two neighboring teeth 57. As a result, the guide profile 67 is always located in two guide grooves 59 so that it continues to maintain an orientation that ensures that during rotation of the star wheel the guide profile ends up in the guide groove of a next tooth.

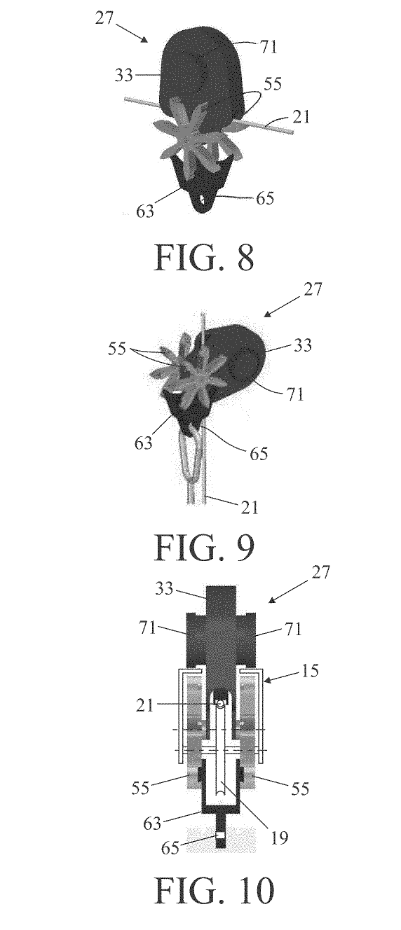

By way of illustration, FIG. 8 shows the descending unit 27 on the descending cable 21 before the passage of the cable guide and FIG. 9 shows the descending unit on the descending cable after passing the cable guide while descending along the descending cable. In both situations, the suspension element 63 is situated with the fastening eye 65 down.

In FIG. 10, the descending unit 27 is shown in front view while being on the descending cable 21 and during the passage of the cable guide 19. The descending unit is provided with two wheels 71 which run over the extended arm 15 until the descending unit passes the cable guide.

Although the present invention is elucidated above on the basis of the given drawings, it should be noted that this invention is not limited whatsoever to the embodiments shown in the drawings. The invention also extends to all embodiments deviating from the embodiments shown in the drawings within the context defined by the claims.

1. A device (1) for descending people (29,31) from, for example, a building (9), comprising:
a ceiling unit (3) provided with an extendable arm (15) having a cable guide (19) at the free end,
a cable drum (25) provided with a brake that restricts the rotation speed of the cable drum,
a descending cable (21) wound on the cable drum and turned over the cable guide having at its end coupling means (23) for coupling to a harness,
characterized in that the device further comprises at least one descending unit (27) which is present on the descending cable (21) in the ceiling unit (3) and is movable along the descending cable, which descending unit comprises:
a housing (33), as well as
a cable wheel shaft (35) connected to the housing,
a rotatable cable wheel (37) present on the cable wheel shaft, over which wheel the descending cable is turned and which wheel is connected to the housing via a freewheel (41) and a centrifugal brake (43),
two guide wheels (39) which guide the descending cable to and from the cable wheel, and
further coupling means (63) for coupling to a further harness,
which centrifugal brake (43) comprises two coupling parts connected with each other comprises, of which a first part is connected to the cable wheel (37) and a second part, in the direction of rotation, is fixed relative to the housing (33).

2. A device according to claim 1, characterized in that the descending unit (27) comprises a planetary gear set (44) with three rotation bodies, of which a first rotation body (45) is connected to said cable wheel (37) and a second rotating body (47) is connected to the first part of the centrifugal brake (43).

3. A device according to claim 2, characterized in that a third rotation body (49) of the planetary gear set (44) is attached to a further centrifugal brake (53) comprising two inter-connectable further parts, of which a first further part is connected to the cable wheel (37) and a second further part, in the direction of rotation, is fixed relative to the housing (33).

4. A device according claim 1, characterized in that:
the descending unit (27) further comprises a star wheel (55) provided with teeth (57), said star wheel is rotatably connected to the housing (33),
wherein the teeth each are provided with a guide groove (59) near the end,
wherein the guide grooves in the teeth extend along a circular arc (61), and
wherein the further coupling means (63) are provided with a guide profile (67) extending over a distance (69) along a portion of the circular arc, which distance is greater than or equal to two times the distance along the arc of a circle along which the guide grooves extends between two adjacent teeth (57).

5. A device as claimed in claim 1, characterized in that the descending cable (21) is turned around the cable wheel (37) over an angle of at least 240 degrees.
